(19) United States
(12) Patent Application Publication
(10) Pub. No.: US 2026/0116615 A1
(43) Pub. Date: Apr. 30, 2026

(54) TRAY WITH DIVIDER FEATURES

(71) Applicant: Graphic Packaging International, LLC, Atlanta, GA (US)

(72) Inventors: Marc Kavanagh, Kent (GB); Jamie Skipper, Leicester (GB)

(21) Appl. No.: 19/369,030

(22) Filed: Oct. 24, 2025

Related U.S. Application Data
(60) Provisional application No. 63/712,002, filed on Oct. 25, 2024.
(60) Provisional application No. 63/724,469, filed on Nov. 25, 2024.

(51) Int. Cl. B65D 5/498; B31B 50/26; B31B 50/81; B31B 105/00; B31B 110/30; B31B 120/25; B65D 5/20; B65D 5/56

(52) U.S. Cl. CPC B65D 5/48048; B31B 50/26; B31B 50/81; B65D 5/2033; B65D 5/2047; B65D 5/563; B31B 2105/00; B31B 2110/30; B31B 2120/25

(57) ABSTRACT

A tray for holding products is disclosed. The tray includes an upper construct that includes an upper flange panel. The tray further includes a lower construct. The lower construct includes a bottom panel and lower side panels foldably connected to the bottom panel and defining a cavity. The lower construct further includes a lower flange panel extending at least partially around the cavity. The lower flange panel is attached to the upper flange panel. The tray further includes a divider construct. The divider construct includes a base panel foldably connected to a divider panel. The divider panel extends from the base panel. The divider construct is at least partially received within the cavity such that the base panel is in face-to-face contact with the bottom panel and the divider panel extends into the cavity.

### CROSS-REFERENCE TO RELATED APPLICATION

The present application claims priority to U.S. Provisional Patent Application No. 63/712,002 filed on Oct. 25, 2024, and to U.S. Provisional Patent Application No. 63/724,469 filed on Nov. 25, 2024.

### INCORPORATION BY REFERENCE

The disclosures of U.S. Provisional Patent Application No. 63/712,002 which was filed on Oct. 25, 2024, and U.S. Provisional Patent Application No. 63/724,469 which was filed on Nov. 25, 2024, are hereby incorporated by reference for all purposes as if presented herein in their entirety.

### TECHNICAL FIELD

This disclosure pertains to blanks for forming trays, trays, and methods for forming the trays from the blanks. More specifically, the present disclosure pertains to divider features such as divider panels extending at an oblique angle from a bottom panel into a cavity of the tray.

### BACKGROUND OF THE DISCLOSURE

Trays are commonly used to hold products such as food products. Trays with divider features can keep certain products separate in various compartments.

### SUMMARY OF THE DISCLOSURE

In some embodiments, a tray for holding products may comprise an upper construct comprising an upper flange panel. The tray may comprise a lower construct comprising a bottom panel. The lower construct may comprise a plurality of lower side panels foldably connected to the bottom panel and defining a cavity. The lower construct may comprise a lower flange panel extending at least partially around the cavity. The lower flange panel may be attached to the upper flange panel. The tray may comprise a divider construct including a base panel foldably connected to a divider panel. The divider panel may extend from the base panel. The divider construct may be at least partially received within the cavity such that the base panel may be in face-to-face contact with the bottom panel and the divider panel may extend into the cavity.

In some embodiments, the base panel may be a first base panel, and the divider construct may further include a second base panel in face-to-face contact with the bottom panel. In various embodiments, the divider panel may be a first divider panel, and the divider construct may further include a second divider panel extending from the second base panel. In some embodiments, a distal end of the first divider panel may be foldably connected to a distal end of the second divider panel. In various embodiments, the bottom panel may define an aperture and the first and second divider panels may extend across the aperture. In some embodiments, the upper construct may further include a plurality of upper sidewalls that may extend from the upper flange panel into the cavity. In various embodiments, the tray may further comprise a polymer layer extending across an interior surface of the cavity. In some embodiments, the divider construct may further include an attachment panel foldably connected to the divider panel and in face-to-face contact with a side panel of the plurality of lower side panels. In various embodiments, the upper flange panel may include a perimeter region defining an opening, and the upper flange panel may further include a central region extending across the opening. In some embodiments, the central region may be aligned with a distal end of the divider panel.

In various embodiments, the divider panel may be a first divider panel, and the divider construct may further include a second divider panel extending from the base panel at an obtuse angle. In some embodiments, the upper construct may include a sidewall panel extending from the upper flange panel and foldably connected to the base panel. In various embodiments, the lower construct may include a lower divider panel foldably connected to the bottom panel extending at an obtuse angle into the cavity. In some embodiments, a distal end of the lower divider panel may be in contact with a distal end of the divider panel.

In some embodiments, a set of blanks for forming a tray for holding products may comprise a first blank for forming an upper construct comprising an upper flange panel. The set of blanks may comprise a second blank for forming a lower construct. The lower construct may comprise a bottom panel. The lower construct may comprise a plurality of lower side panels foldably connected to the bottom panel and defining a cavity. The lower construct may comprise a lower flange panel extending at least partially around the cavity. The lower flange panel may be attached to the upper flange panel. The set of blanks may comprise a third blank for forming a divider construct including a base panel foldably connected to a divider panel. The divider panel may extend from the base panel. The divider construct may be at least partially received within the cavity such that the base panel may be in face-to-face contact with the bottom panel and the divider panel may extend into the cavity. In various embodiments, the base panel may be a first base panel, and the divider construct may further include a second base panel in face-to-face contact with the bottom panel. In some embodiments, the divider panel may be a first divider panel, and the divider construct may further include a second divider panel extending from the second base panel.

In some embodiments, a method of forming a tray for holding products from a set of blanks may comprise forming an upper construct from a first blank, the upper construct including an upper flange panel. The method may comprise forming a lower construct from a second blank by folding a plurality of lower side panels upward from a bottom panel to define a cavity. A lower flange panel of the lower construct may extend at least partially around the cavity. The method may comprise attaching the lower flange panel to the upper flange panel. The method may comprise forming a divider construct from a third blank by extending a divider panel from a base panel. The method may comprise receiving the divider construct within the cavity such that the base panel may be in face-to-face contact with the bottom panel. In various embodiments, the base panel may be a first base panel, and the divider construct may further include a second base panel in face-to-face contact with the bottom panel. In some embodiments, the divider panel may be a first divider panel, and the divider construct may further include a second divider panel extending from the second base panel.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1A is a perspective view of a tray formed from a set of blanks according to a first embodiment of the disclosure.

FIG. 1B is an exploded view of the tray shown in FIG. 1A that includes a liner, an upper construct formed from a first blank, a lower construct formed from a second blank, and a divider construct formed from a third blank, according to the first embodiment of the disclosure.

FIG. 2A is a plan view of a blank for forming the upper construct of the tray shown in FIGS. 1A and 1B.

FIG. 2B is a plan view of a blank for forming the lower construct of the tray shown in FIGS. 1A and 1B.

FIG. 2C is a plan view of a blank for forming the divider construct of the tray shown in FIGS. 1A and 1B.

FIG. 3A is a perspective view of a tray formed from a set of blanks according to a second embodiment of the disclosure.

FIG. 3B is an exploded view of the tray shown in FIG. 3A that includes an upper construct formed from a first blank, a lower construct formed from a second blank, and a divider construct formed from a third blank.

FIG. 4A is a perspective view of a tray formed from a set of blanks according to a third embodiment of the disclosure.

FIG. 4B is an exploded view of the tray shown in FIG. 4A that includes an upper construct formed from a first blank, a lower construct formed from a second blank, and a divider construct formed from a third blank.

FIG. 5A is a perspective view of a tray formed from a set of blanks according to a fourth embodiment of the disclosure.

FIG. 5B is an exploded view of the tray shown in FIG. 5A that includes an upper construct formed from a first blank, a lower construct formed from a second blank, and a divider construct formed from a third blank.

FIG. 6A is a perspective view of a tray formed from a set of blanks according to a fifth embodiment of the disclosure.

FIG. 6B is an exploded view of the tray shown in FIG. 6A that includes an upper construct formed from a first blank and a lower construct formed from a second blank.

FIG. 7A is a perspective view of a tray formed from a set of blanks according to a sixth embodiment of the disclosure.

FIG. 7B is an exploded view of the tray shown in FIG. 7A that includes an upper construct formed from a first blank and a lower construct formed from a second blank.

Corresponding parts are designated by corresponding reference numbers throughout the drawings.

### DETAILED DESCRIPTION

The present disclosure generally relates to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

Trays described herein can be used for holding one or more articles such as food products, e.g., portioned retail food products that can include one or more cookies, crackers, cakes, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In embodiments, other types of articles that can include food products and/or non-food products can be placed in the tray for service to a customer. In some embodiments, such products can be contained in additional packaging and then placed in the tray. The tray could be otherwise shaped and arranged and could be used to hold other products and/or articles in similar or different environments without departing from the disclosure.

In this specification, the terms “inner,” “interior,” “outer,” “exterior,” “lower,” “bottom,” “upper,” and “top” indicate orientations determined in relation to fully erected and upright cartons. As described herein, constructs can be formed with multiple walls, panels, portions, tabs, flaps, fold lines, and/or other aspects, which may be designated herein in terms relative to one another, e.g., “first,” “second,” “third,” etc., in sequential or nonsequential reference, without departing from the disclosure.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A tray for holding products is designed to keep multiple items separated and organized during storage or transport. The tray is made from folded sheet material, often cardboard, paperboard or similar, and has a sturdy bottom, raised sides, and folded flanges that give it strength and help retain its shape.

Inside the tray, divider panels are attached so that the products stay in their own spaces and do not bump into each other or intermix. The dividers can be oriented and/or connected in various ways, making the tray useful for many different types of products. Some versions of the tray may also have a protective lining to improve cleanliness, to enable air-tight sealing and/or to improve strength.

The tray can be formed from constructs that are shaped from flat blanks and assembled by folding and attaching the panels together. This construction allows the tray to be shipped and stored flat, saving space, and then quickly built when needed. The design may increase reliability and helps keep products safe and secure until use. Once the tray is constructed the trays may nest to save space.

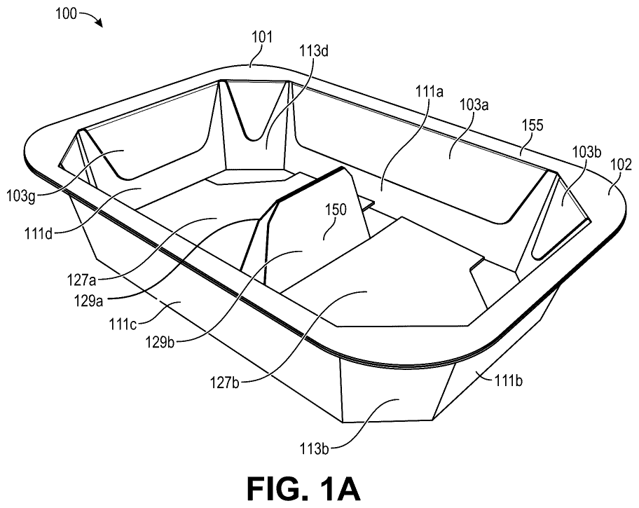

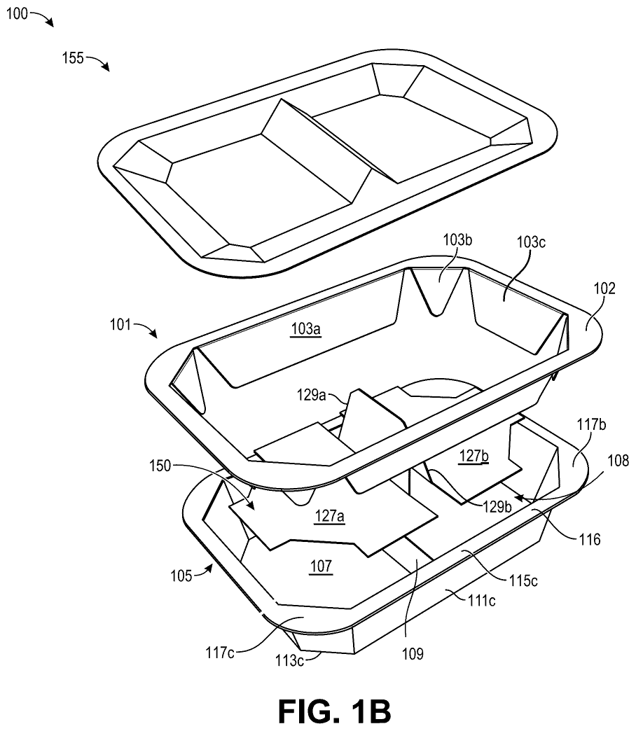

FIG. 1A is a perspective view of a tray 100 formed from a set of blanks according to a first embodiment of the disclosure. As shown in FIG. 1A, the set of blanks can be used to form an upper construct 101, a lower construct 105, and a divider construct 150 (see FIG. 1B) that can be attached to each other to assemble the tray 100.

An exploded view of tray 100 is shown in FIG. 1B. FIGS. 1A and 1B will be now be described simultaneously. In the illustrated configuration, at least a bottom panel 107 of the lower construct 105 can form a bottom wall of the tray 100. The upper construct 101 and the lower construct 105 can cooperate form a sidewall of the tray 100 extending upwardly from the bottom wall 107 and extending at least partially around an interior of the tray 100, as described in more detail below. At least an upper flange panel 102 of the upper construct 101 can form a flange of the tray 100 extending outwardly from the sidewall. In some embodiments, the upper flange panel 102 can be attached in at least partial face-to-face contact to a lower flange panel 116 to form a reinforced or two-ply flange of the tray 100.

At least divider panels 129a, 129b of the divider construct 150 can be positioned extending upwardly at an oblique angle from the bottom wall 107 or from a base panel 127a, 127b to form a divider or divider wall to provide a first compartment and a second compartment in the interior of the tray 100. The multi-compartment arrangement of the interior of the tray can provide for selective service of different and/or portioned food products, or can provide for accessories (e.g., condiments or dressings) separate from a food product, to avoid intermingling thereof, etc.

The tray 100 described herein thus provides a versatile arrangement for selective service of a variety of food products and/or different portions of such food products via the engagement of an upper construct 101, a lower construct 105, and a divider construct 150 to form a divider wall in the interior of the tray 100. Divider features of the upper construct 101, the divider construct 150, and the lower blank 105 and the tray 100 formed therefrom can thus include features that form the divider wall in combinations and sub-combinations.

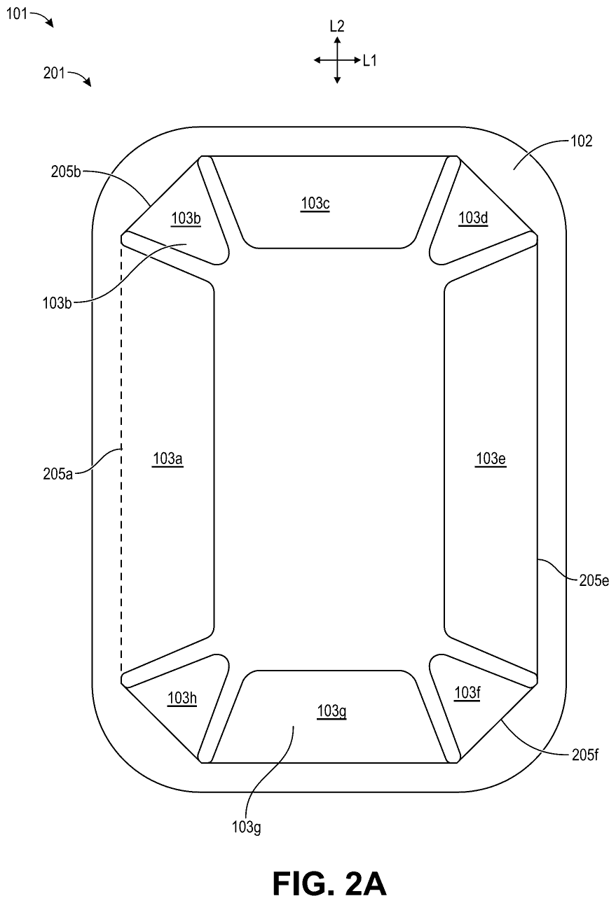

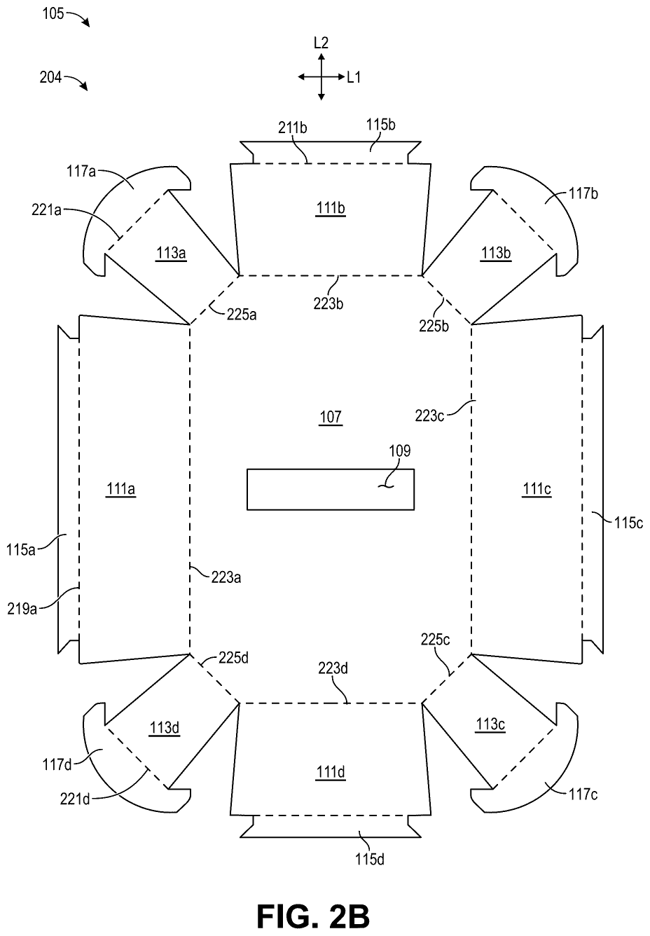

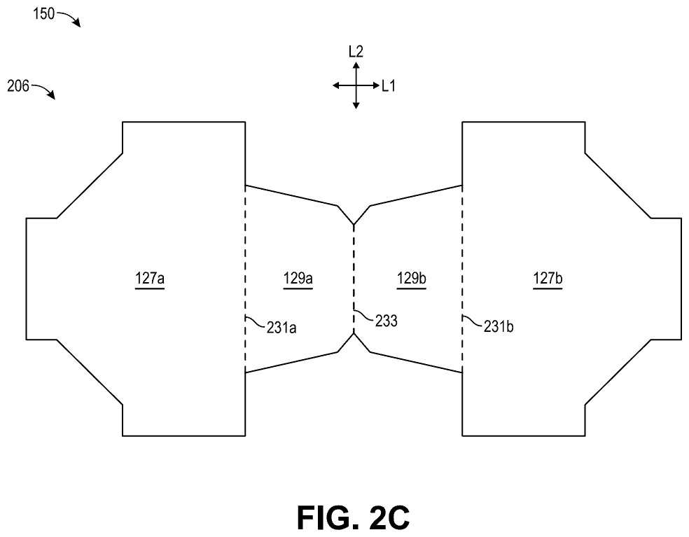

FIG. 1B is an exploded view of the tray 100 showing a liner 155, the upper construct 101 formed from a first blank 201 (see FIG. 2A), the lower construct 105 formed from a second blank 204 (see FIG. 2B), and the divider construct 150 formed from a third blank 206 (see FIG. 2C) according to the first embodiment of the disclosure.

Upper construct 101 (see FIG. 2A) includes a plurality of upper side panels 103a-103h that are folded at least partially downward relative to upper flange panel 102 along respective fold lines 205a-205h. Lower construct 105 (see FIG. 2B) includes a plurality of lower side panels 111a-111d and a plurality of lower end panels 113a-113d that can be folded at least partially upward relative to a bottom panel 107 to form a cavity 108 (see FIG. 1B). Side flange panels 115a-115d and end flange panels 117a-117d of the lower construct 105 can be folded at least partially outwardly away from the interior of the tray 100 to form a lower flange panel 116 (see FIG. 1B). An aperture 109 or opening can be defined within the bottom panel 107 and may enable nesting of the assembled trays. More particularly, the aperture 109 may be sized to at least partially receive the divider panels 129a, 129b.

Divider construct 150 includes divider panels 129a, 129b that can be positioned in generally oblique relation with the bottom panel 107 and/or base panels 127a, 127b extending away therefrom into the cavity 109 to form a divider of the tray 100. The divider panels 129a, 129b can extend over the aperture 109 of the bottom panel 107 when forming the divider.

During assembly of tray 100, respective upper side panels 103a-103h of the upper construct 101 can be positioned in at least partial face-to-face contact with respective lower side panels 111a-111d or respective lower end panels 113a-113d of the lower construct 105 to couple the upper construct 101 to the lower construct 105 and form the tray 100 therefrom. For example, upper side panel 103e of the upper construct 101 can be positioned in face-to-face contact with lower side panel 111c of the lower construct 105. In some embodiments, such an arrangement can be at least partially maintained with one or more applications of an adhesive such as glue. The divider construct 150 can be at least partially received in the cavity 109 formed by the lower construct 105 or in the interior of the tray 100 to form separate tray sections as described above.

Liner 155 (see FIG. 1B) is shown as separate from the upper construct 101, divider construct 150, and lower construct 105 and is applied to the tray 100 (e.g., blow molded within the tray interior). However, in some embodiments, the liner can be applied to one more of the blanks used to form the tray 100 before the constructs 101, 150, 105 are formed and assembled. One, two, or all of the blanks and/or the tray 100 formed therefrom can, in some embodiments, be provided with the liner 155 that comprises a plastic layer such as polyethylene, a polyethylene terephthalate (PET) material, or any other thermoplastic material, or a bioplastic, such as vegetable oil or starch-based plastics. In one embodiment, such liner 155 can comprise polyethylene that can be softened and fused to one or more of the blanks and/or the tray formed therefrom. In an alternative embodiment, a liner that can be attached to the blank(s) and/or the tray formed therefrom can comprise PET or a similar material that is at least partially attached to the blank and/or tray by a heat seal layer (e.g., a thermoformable sealant grade transparent polyester packaging film, such as Mylar® XMPOL12 available from DuPont Teijin Films U.S. Limited Partnership of Hopewell, Virginia, or any suitable thermoformable sealant or adhesive, any suitable heat or pressure activated adhesive, or any other suitable material), wherein a PET liner can be more suitable for uses that require heating of the container in an oven.

Such a liner can be at least partially attached to the blank(s) and/or the tray formed therefrom for being positioned in contact with one or more food products held in the tray (e.g., during heating). In one embodiment, after heating and/or serving the food product, the blank or tray and an accompanying liner can be separated to allow both the blank and the liner to be disposed of (e.g., recycled, renewed, reused, etc.) separately. Optionally, the blank or tray can be provided separately from or without the liner.

In some embodiments, the liner can at least partially maintain the relative arrangement of respective panels, end flaps, and features of the upper construct 101, divider construct 150, and lower construct 105 of the tray 100, and can overlie seams therebetween so as to provide leak-resistant properties to avoid egress of one or more fluids from the interior of the tray to portions of the upper construct, lower construct, or divider construct.

FIG. 2A illustrates an exterior surface of a first blank 201 or upper blank for forming the upper construct 101 (FIG. 1B) according to the first embodiment of the disclosure. As shown, the blank 201 has a lateral axis L1 and a longitudinal axis L2. The blank 201 can include the upper flange panel 102 at least partially defining a central opening or cutout. The plurality of upper side panels 103a-103h can be foldably connected along fold lines 205a-205h to the upper flange panel 102 and positioned extending into the central opening defined by the upper flange panel 102. For simplicity, only a few of the upper side panels 103a-103h are shown with element numbers in FIG. 2A.

The upper side panels 103a-103h can have various shapes and sizes. For example, upper side panels 103a, 103e can form large isosceles trapezoids and are foldably connected to the upper flange panel 102 along respective longitudinal fold lines 205a, 205e. Upper side panels 103c, 103g can form smaller isosceles trapezoids and are foldably connected to the upper flange panel 102 along respective lateral fold lines 205c, 205g. Upper side panels 103b, 103d, 103f, and 103h can form triangular panels with a rounded distal end and are foldably connected to the upper flange panel 102 along respective oblique fold lines 205b, 205d, 205f, and 205h. The upper side panels 103b, 103d, 103f, and 103h can also be referred to as upper end panels. Although eight upper side panels are shown in FIG. 2A, the blank 201 can include any number of upper side panels, including a single upper side panel or zero upper side panels. The upper side panels 103a-103h could be omitted or could be otherwise shaped, arranged, positioned, or configured without departing from the disclosure.

FIG. 2B illustrates an exterior surface of a second blank 204 or lower blank for forming the lower construct 105 (FIG. 1B) according to the first embodiment of the disclosure. As shown, the blank 204 has a lateral axis L1 and a longitudinal axis L2. The blank 204 can include the bottom panel 107, lower side panels 111a-111d foldably connected along respective foldlines to the bottom panel 107, and lower end panels 113a-113d foldably connected to the bottom panel 107 along respective fold lines. The lower side panels 111a-111d and lower end panels 113a-113d can have various shapes and sizes. For example, lower side panels 111a, 111c can form large rectangular shapes and are connected to the bottom panel 107 along longitudinal fold lines 223a, 223c. The lower side panels 111b, 111d can form smaller rectangular shapes and are connected to the bottom panel 107 along lateral fold lines 223b, 223d.

The lower end panels 111a-111d can form smaller rectangular shapes and are foldably connected to the bottom panel 107 along oblique fold lines 225a-225d. Additionally, the blank 204 can include a plurality of side flange panels 115a-115d foldably connected to respective lower side panels 111a-111d and end flange panels 117a-117d foldably connected to respective lower end panels 113a-113d. For example, side flange panel 115a is foldably connected to lower side panel 111a along fold line 219a, side flange panel 115b is foldably connected to lower side panel 111b along fold line 219b, etc. Similarly, end flange panel 117a is foldably connected to lower end panel 113a along fold line 221a, end flange panel 117b is foldably connected to lower end panel 113b along fold line 221b, etc.

An aperture 109 or opening can be defined within the bottom panel 107. Although four lower side panels 111a-111d are shown in FIG. 2B, the blank 204 can include any number of lower side panels, including a single lower side panel or zero lower side panels. Although four lower end panels 113a-113d are shown in FIG. 2B, the blank 204 can include any number of lower end panels, including a single lower end panel or zero lower end panels. The lower side panels 111a-111d, lower end panels 113a-113d, side flange panels 115a-115d, end flange panels 117a-117d, bottom panel 107, or the opening 109 could be omitted or could be otherwise shaped, arranged, positioned, or configured without departing from the disclosure.

FIG. 2C illustrates an exterior surface of a third blank 206 or divider blank for forming a divider construct 150 (FIG. 1B) according to the first embodiment of the disclosure. As shown, the blank 206 has a longitudinal axis L1 and a lateral axis L2. The blank 206 can include base panels 127a, 127b and divider panels 129a, 129b. First base panel 127a is foldably connected to first divider panel 129a along a lateral foldline 231a. Second base panel 127b is foldably connected to second divider panel 129b along a lateral foldline 231b. The first divider panel 129a is foldably connected to the second divider panel 129b along a lateral foldline 233. The base panels 127a, 127b or the divider panels 129a, 129b could be omitted or could be otherwise shaped, arranged, positioned, or configured without departing from the disclosure.

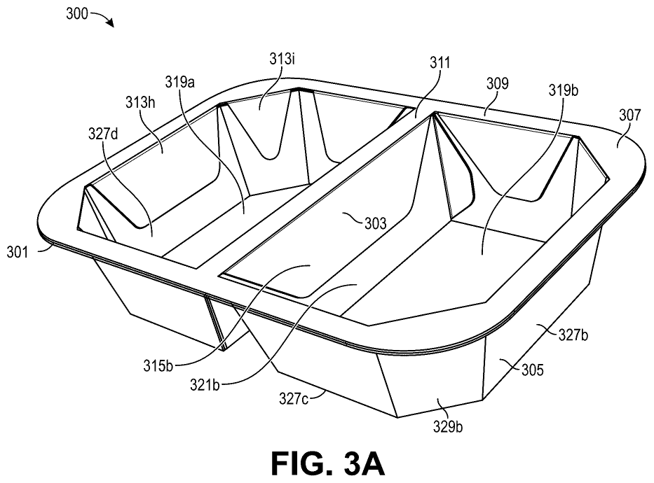

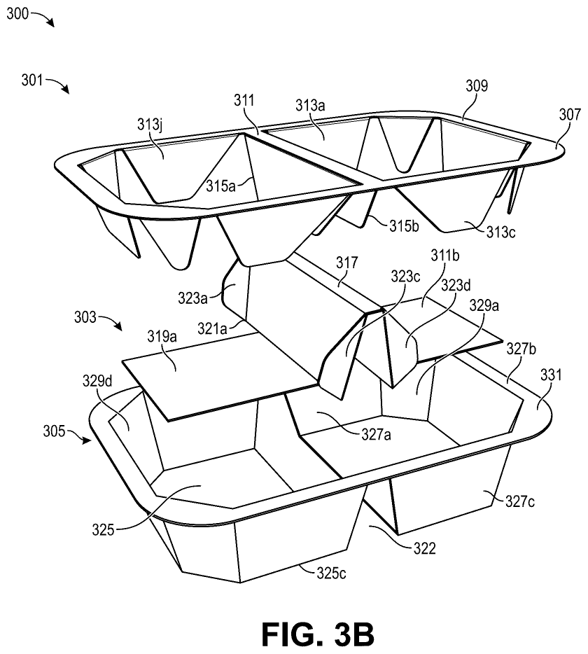

FIG. 3A is a perspective view of a tray 300 formed from a set of blanks according to a second embodiment of the disclosure. The tray 300 can include any of the components or features described for any other tray described in this application, including tray 100 associated with FIGS. 1A-2C. The second embodiment is generally similar to the prior embodiment, except for variations noted and variations that will be apparent to one of ordinary skill in the art. The set of blanks can be used to form an upper construct 301, a lower construct 305, and a divider construct 303 that can be attached to each other to assemble the tray 300. In the figures, the liner (e.g., liner 155 in FIG. 1B) has been removed for clarity.

The upper construct 301 is similar to upper construct 101, but upper flange 307 of upper construct 301 includes a central portion 311 that divides the opening defined by perimeter portion 309 into two openings. The central portion 311 is foldably connected to central panels 315a, 315b that fold downward from the central portion 311 and contact the divider panels 321a, 321b in face-to-face contact to reinforce divider features of the tray 300. The divider panels 321a, 321b extend into the interior of the tray 300 and contact at least a portion of the central portion 311 such that the first and second compartments of the tray 300 are fully isolated from each other. Further, the tray 300 is stackable in that a divider of a second tray 300 can fit in a bottom cavity formed under a first tray 300.

FIG. 3B is an exploded view of an upper construct 301 of the tray 300 formed from a first blank, a lower construct 305 formed from a second blank, and a divider construct 303 formed from a third blank according to the second embodiment of the disclosure. The upper construct 301, the lower construct 305, the divider construct 303 and the blanks can include any of the components or features described for any other construct or blank described in this application. For example, the lower construct 305 can include any component or feature described for lower construct 105 (FIG. 1B).

As mentioned above, the upper flange 307 of the upper construct 301 can include a central portion 311. The divider construct 303 can be like divider construct 150, but the divider construct 303 can include a connecting panel 317 that connects distal ends of divider panels 321a, 321b. The divider panels 321a, 321b can be foldably connected to the connecting panel 317 and the respective base panels 319a, 319b. Additionally, each of the divider panels 321a, 321b can be foldably connected to two attachment panels 323a-323d. For example, divider panel 321a is foldably connected to attachment panels 323a, 323c.

The lower construct 305 is similar to lower construct 105, but the lower construct 305 includes an aperture 322 that is defined within bottom panel 325 and lower side panels 327a, 327c. When the tray 300 is formed from the constructs, the central portion 311 of the upper flange panel 307 is attached to the connecting panel 317 in face-to-face contact, attachment panels 323a, 323b are attached to the lower side panel 327a in face-to-face contact, and the attachment panels 323c, 323d are attached to the lower side panel 327c in face-to-face contact. The divider panels 321a, 321b and the connecting panel 317 extend over the aperture 322.

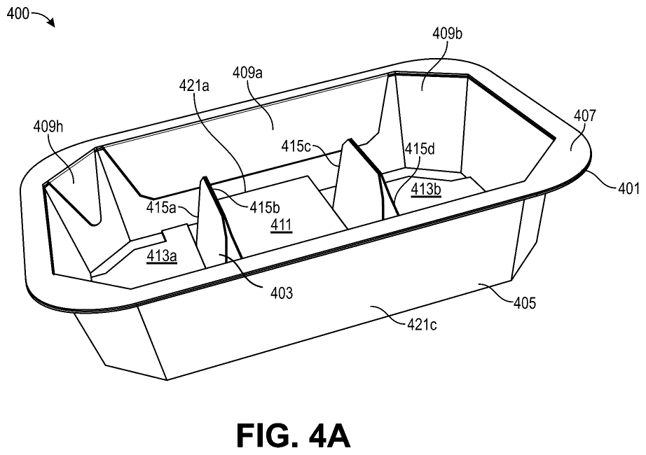

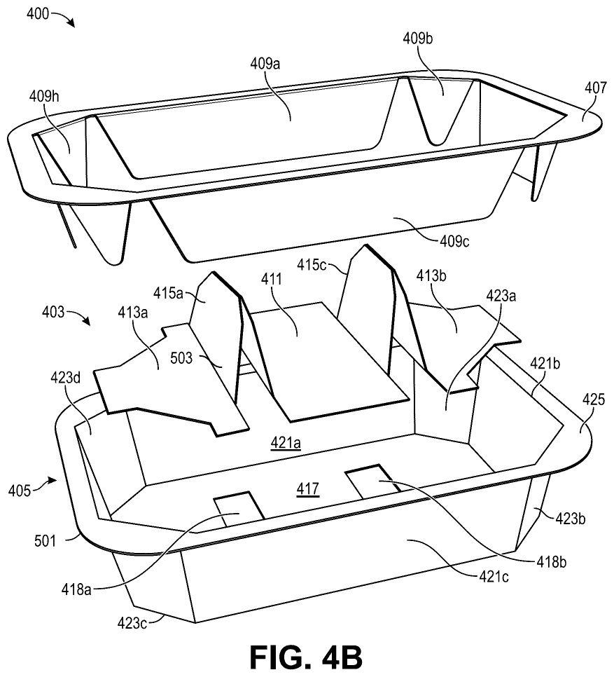

FIG. 4A is a perspective view of a tray 400 formed from a set of blanks according to a third embodiment of the disclosure. The tray 400 can include any of the components or features described for any other tray described in this application, including tray 100 associated with FIGS. 1A-2C and tray 300 associated with FIGS. 3A and 3B. The third embodiment is generally similar to the prior embodiments, except for variations noted and variations that will be apparent to one of ordinary skill in the art. The set of blanks can be used to form an upper construct 401, a lower construct 405, and a divider construct 403 that can be attached to each other to assemble the tray 400. In the figures, the liner (e.g., liner 155 in FIG. 1B) has been removed for clarity.

The divider construct 403 is similar to divider construct 150 (FIG. 1B), except the divider construct 403 includes a central base panel 411 in addition to base panels 413a, 413b and four divider panels 415a-415d for forming two dividers in the tray 400 instead of a single divider. A first divider panel 415a is foldably connected to base panel 413a, divider panels 415b, 415c are foldably connected to central base panel 411, and divider panel 415d is foldably connected to base panel 413b. The first divider panel 415a and second divider panel 415b extend obliquely into an interior of the tray 400 and connect at distal ends to form a first divider of the tray 400. Similarly, the third divider panel 415c and fourth divider panel 415d extend obliquely into an interior of the tray 400 and connect at distal ends to form a second divider of the tray 400. The two dividers separate the tray 400 into three compartments.

FIG. 4B is an exploded view of an upper construct 401 of the tray 400 formed from a first blank, a lower construct 405 formed from a second blank, and a divider construct 403 formed from a third blank according to the third embodiment of the disclosure. The upper construct 401, the lower construct 405, the divider construct 403 and the blanks can include any of the components or features described for any other construct or blank described in this application. For example, the lower construct 405 can include any component or feature described for lower construct 105 (FIG. 1B).

As described above, the divider construct 403 can be similar to divider construct 150, but the divider construct 403 can include four divider panels 415a-415d. Each of the divider panels 415a, 415b, 415c, 415d can extend at an oblique angle from a respective base panel into a cavity formed by the lower construct 405 to connect at distal ends to form a divider with a neighboring divider panel. The lower construct 405 can be like lower construct 105 (FIG. 1B), but the lower construct 405 includes two apertures 418a, 418b that can be sized and shaped to receive divider panels of an adjacent nested tray. When the tray 400 is formed, divider panels 415a, 415b extend over the first aperture 418a and divider panels 415c, 415d extend over the second aperture 418b.

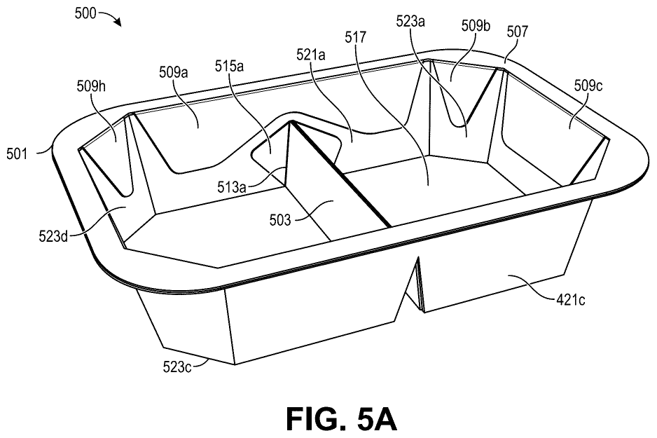

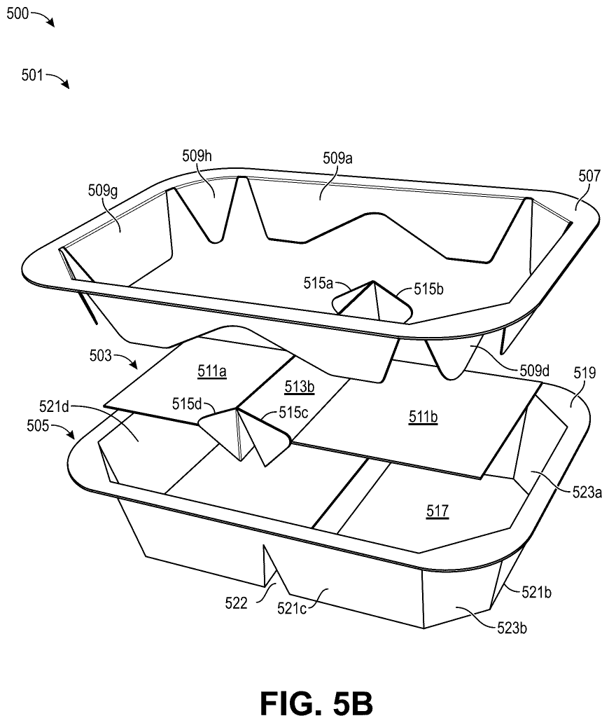

FIG. 5A is a view of a tray 500 formed from a set of blanks according to a fourth embodiment of the disclosure. The tray 500 can include any of the components or features described for any other tray described in this application. The fourth embodiment is generally like the prior embodiments, except for variations noted and variations that will be apparent to one of ordinary skill in the art. The set of blanks can be used to form an upper construct 501, a lower construct 505, and a divider construct 503 that can be attached to each other to assemble the tray 500. The tray 500 is generally similar to tray 100 where features of the constructs 501, 503, 505 allow tray 500 to be stackable (e.g., nestable). The additional features are described with respect to FIG. 5B. In the figures, the liner (e.g., liner 155 in FIG. 1B) has been removed for clarity.

FIG. 5B is an exploded view of an upper construct 501 of the tray 500 formed from a first blank, a lower construct 505 formed from a second blank, and a divider construct 503 formed from a third blank according to the fourth embodiment of the disclosure. The upper construct 501, the lower construct 505, the divider construct 503 and the blanks can include any of the components or features described for any other construct or blank described in this application. For example, the lower construct 505 can include any component or feature described for lower construct 105 (FIG. 1B).

The upper construct 501 is generally like upper construct 101 (FIG. 1B), however, upper sidewalls 509a, 509e of upper construct 501 are shaped differently than their counterparts of upper construct 101. The divider construct 503 is generally like divider construct 101 (FIG. 1B), but divider panels 513a, 513b are each foldably connected to two attachment panels 515a, 515d and 515b, 515c, respectively. The lower construct 505 includes an aperture 522 that is defined in bottom panel 517 as well as lower side panels 521a, 521c. When the constructs 501, 503, 505 combine to form tray 500, divider panels 513a, 513b extend over the aperture 522 and the attachment panels are attached to respective lower side panels 521a, 521c in face-to-face contact.

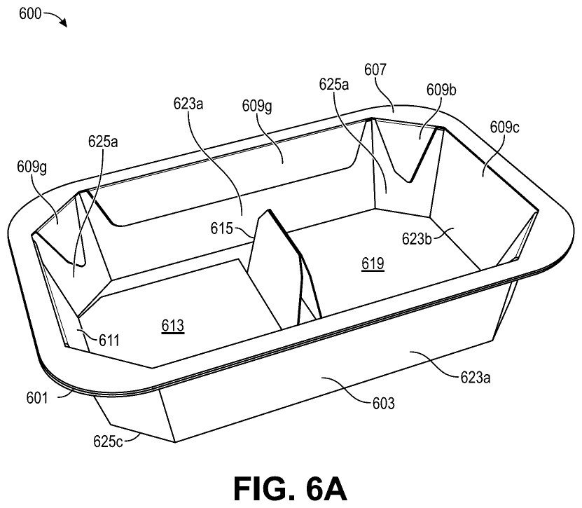

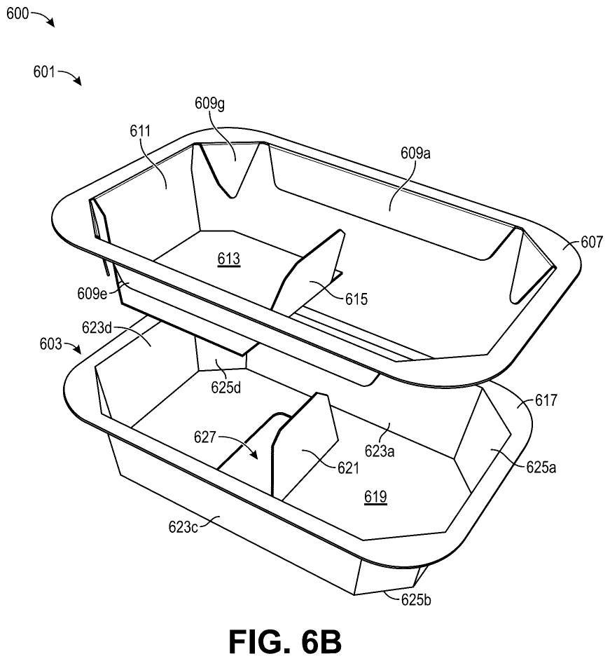

FIG. 6A is a perspective view of a tray 600 formed from a set of blanks according to a fifth embodiment of the disclosure. The tray 600 can include any of the components or features described for any other tray described in this application, including tray 100 associated with FIGS. 1A-2C. The fifth embodiment is generally like the prior embodiments, except for variations noted and variations that will be apparent to one of ordinary skill in the art. The set of blanks can be used to form an upper construct 601 and a lower construct 603 that can be attached to each other to assemble the tray 600. The tray 600 is generally similar to tray 100 but formed from two constructs instead of three. In the figures, the liner (e.g., liner 155 in FIG. 1B) has been removed for clarity.

FIG. 6B is an exploded view of an upper construct 601 of the tray 600 formed from a first blank and a lower construct 603 formed from a second blank according to the fifth embodiment of the disclosure. The upper construct 601, the lower construct 603, and the blanks can include any of the components or features described for any other construct or blank described in this application. For example, the lower construct 603 can include any component or feature described for lower construct 105 (FIG. 1B).

The upper construct 601 is generally similar to upper construct 101 (FIG. 1B), however, the upper construct 601 includes an upper attachment panel 611 or upper sidewall foldably connected to an upper base panel 613. The upper base panel 613 is foldably connected to an upper divider panel 615. Similarly, the lower construct 603 is generally similar to lower construct 105 (FIG. 1B), but the lower construct 603 includes a lower divider panel 621 foldably connected to bottom panel 619.

When the tray 600 is formed from the upper construct 601 and the lower construct 603, the upper base panel 613 is in face-to-face contact with at least a portion of the bottom panel 619. Upper divider panel 615 extends at an oblique angle from the upper base panel 613 into a cavity formed by the lower construct 603. The lower divider panel 621 extends at an oblique angle from the bottom panel 619 into the cavity and contacts the upper divider panel at a distal end to form a divider for the tray. The upper divider panel 615, the lower divider panel 621, and the upper base panel 613 extend over at least a portion of an aperture 627 formed in the bottom panel 619.

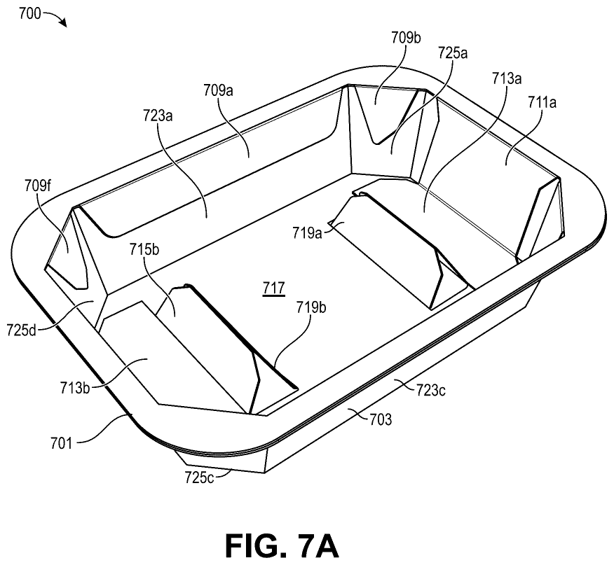

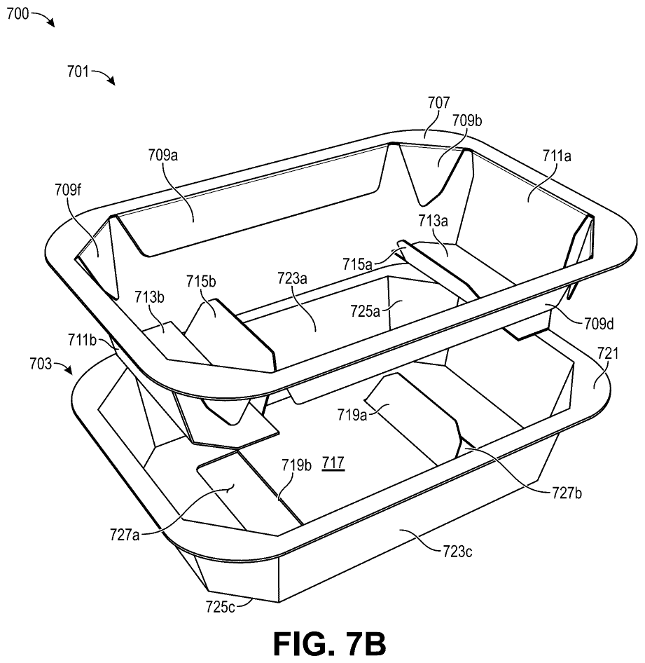

FIG. 7A is a perspective view of a tray 700 formed from a set of blanks according to a sixth embodiment of the disclosure. The tray 700 can include any of the components or features described for any other tray described in this application, including tray 100 associated with FIGS. 1A-2C. The sixth embodiment is generally like the prior embodiments, except for variations noted and variations that will be apparent to one of ordinary skill in the art. The set of blanks can be used to form an upper construct 701 and a lower construct 703 (see FIG. 7B) that can be attached to each other to assemble the tray 700. In the figures, the liner (e.g., liner 155 in FIG. 1B) has been removed for clarity.

FIG. 7B is an exploded view of an upper construct 701 of the tray 700 formed from a first blank and a lower construct 703 formed from a second blank according to the sixth embodiment of the disclosure. The upper construct 701, the lower construct 703, and the blanks can include any of the components or features described for any other construct or blank described in this application. For example, the lower construct 703 can include any component or feature described for lower construct 105 (FIG. 1B).

The upper construct 701 is generally like upper construct 601 (FIG. 6B), however, the upper construct 701 includes two upper attachment panels 711a, 711b, each foldably connected to a separate upper base panel 713a, 713b, respectively. First upper base panel 713a is foldably connected to first upper divider panel 715a. Second upper base panel 713b is foldably connected to second upper divider panel 715b. Similarly, the lower construct 703 is generally similar to lower construct 603 (FIG. 6B), but the lower construct 603 includes two lower divider panels 719a, 719b.

When the tray 700 is formed from the upper construct 701 and the lower construct 703, the two upper base panels 713a, 713b are each in face-to-face contact with at least a portion of the bottom panel 717. First upper divider panel 715a extends at an oblique angle from the first upper base panel 713a into a cavity formed by the lower construct 703. First lower divider panel 719a extends at an oblique angle from the bottom panel 719 into the cavity and contacts the first upper divider panel 715a at a distal end to form a first divider for the tray. Second upper divider panel 715b extends at an oblique angle from the second upper base panel 713b into a cavity formed by the lower construct 703. Second lower divider panel 719b extends at an oblique angle from the bottom panel 717 into the cavity and contacts the second upper divider panel 715b at a distal end to form a second divider for the tray. The first upper divider panel 715a and the first lower divider panel 719a extend over at least a portion of a first aperture 727b formed in the bottom panel 717. The second upper divider panel 715b and the second lower divider panel 719b extend over at least a portion of a second aperture 727a formed in the bottom panel 717.

Any of the features of the various embodiments of the disclosure can be combined with, replaced by, or otherwise configured with other features of other embodiments of the disclosure without departing from the scope of this disclosure.

In general, the blank may be constructed from paperboard having a caliper so that it is heavier and more rigid than ordinary paper. In some embodiments the paperboard may be between 0.005 inches and 0.075 inches thick, between 0.010 inches and 0.050 inches thick or between 0.020 inches and 0.040 inches thick. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. Various additions, modifications, changes, etc., could be made to the embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure. Furthermore, certain features and characteristics of each embodiment may be selectively interchanged and applied to other illustrated and non-illustrated embodiments of the disclosure.

What is claimed is:

1. A tray for holding products, the tray comprising:
an upper construct comprising an upper flange panel;
a lower construct comprising:
a bottom panel;
a plurality of lower side panels foldably connected to the bottom panel and defining a cavity; and
a lower flange panel extending at least partially around the cavity;
wherein the lower flange panel is attached to the upper flange panel; and
a divider construct including a base panel foldably connected to a divider panel, the divider panel extending from the base panel, wherein the divider construct is at least partially received within the cavity such that the base panel is in face-to-face contact with the bottom panel and the divider panel extends into the cavity.

2. The tray of claim 1, wherein the base panel is a first base panel, the divider construct further including a second base panel in face-to-face contact with the bottom panel.

3. The tray of claim 2, wherein the divider panel is a first divider panel, the divider construct further including a second divider panel extending from the second base.

4. The tray of claim 3, wherein at least one of the first divider panel and the second divider panel extends from the base panel at an obtuse angle.

5. The tray of claim 3, wherein a distal end of the first divider panel is foldably connected to a distal end of the second divider panel.

6. The tray of claim 3, wherein the bottom panel defines an aperture and wherein the first and second divider panels extend across the aperture.

7. The tray of claim 1, wherein the upper construct further includes a plurality of upper sidewalls that extend from the upper flange panel into the cavity.

8. The tray of claim 1, further comprising a polymer layer extending across an interior surface of the cavity.

9. The tray of claim 1, wherein the divider construct further includes an attachment panel foldably connected to the divider panel and in face-to-face contact with a side panel of the plurality of lower side panels.

10. The tray of claim 1, wherein the upper flange panel includes a perimeter region defining an opening, the upper flange panel further including a central region extending across the opening.

11. The tray of claim 10, wherein the central region is aligned with a distal end of the divider panel.

12. The tray of claim 10, wherein the divider panel is a first divider panel, the divider construct further including a second divider panel extending from the base panel at an obtuse angle.

13. A set of blanks for forming a tray, the set of blanks comprising:
a first blank for forming an upper construct, the first blank comprising an upper flange panel;
a second blank for forming a lower construct, the second blank comprising:
a bottom panel;
a plurality of lower side panels foldably connected to the bottom panel and for defining a cavity; and
a lower flange panel extending at least partially around the cavity;
wherein the lower flange panel is for attachment to the upper flange panel when the tray is formed from the set of blanks; and
a third blank for forming a divider construct, the third blank including a base panel foldably connected to a divider panel, the divider panel is for extending from the base panel when the tray is formed from the set of blanks, the divider construct is at least partially received within the cavity such that the base panel is in face-to-face contact with the bottom panel when the tray is formed from the set of blanks, and the divider panel is for extending into the cavity when the tray is formed from the set of blanks.

14. The set of blanks of claim 13, wherein the base panel is a first base panel, the third blank comprises a second base panel for being in face-to-face contact with the bottom panel when the tray is formed from the set of blanks.

15. The set of blanks of claim 14, wherein the divider panel is a first divider panel, the third blank comprises a second divider panel for extending from the second base panel when the tray is formed from the set of blanks.

16. The set of blanks of claim 15, wherein a distal end of the first divider panel is foldably connected to a distal end of the second divider panel.

17. The set of blanks of claim 15, wherein the bottom panel comprises an aperture and the first and second divider panels extend across the aperture when the tray is formed from the set of blanks.

18. The set of blanks of claim 13, wherein the first blank comprises a plurality of upper sidewalls that extend from the upper flange panel into the cavity.

19. The set of blanks of claim 13, wherein the third blank further includes an attachment panel foldably connected to the divider panel and for being in face-to-face contact with a side panel of the plurality of lower side panels when the tray is formed from the set of blanks.

20. The set of blanks of claim 13, wherein the upper flange panel includes a perimeter region defining an opening, the upper flange panel further including a central region extending across the opening.

21. The set of blanks of claim 20, wherein the divider panel is a first divider panel, the third blank further including a second divider panel for extending from the base panel when the tray is formed from the set of blanks.

22. A method of forming a tray from a set of blanks, the method comprising:
forming an upper construct from a first blank, the upper construct including an upper flange panel;
forming a lower construct from a second blank by folding a plurality of lower side panels upward from a bottom panel to define a cavity, wherein a lower flange panel of the lower construct extends at least partially around the cavity;
attaching the lower flange panel to the upper flange panel;
forming a divider construct from a third blank by extending a divider panel from a base panel; and
receiving the divider construct within the cavity such that the base panel is in face-to-face contact with the bottom panel.

23. The method of claim 22, wherein the base panel is a first base panel, the divider construct further including a second base panel in face-to-face contact with the bottom panel.

24. The method of claim 22, wherein the divider panel is a first divider panel, the divider construct further including a second divider panel extending from the second base panel.

25. A tray for holding products, the tray comprising:
an upper construct comprising an upper flange panel, an upper base panel, and an upper divider panel foldably connected to the upper base panel; and
a lower construct comprising a lower flange panel, a plurality of lower side panels foldably connected to the bottom panel, and a lower divider panel foldably connected to the bottom panel,
the lower flange panel is attached to the upper flange panel, and the upper divider panel and the lower divider panel cooperate to form a divider in an interior of the tray.

26. The tray of claim 25, wherein the upper base panel is in face-to-face contact with at least a portion of the bottom panel.

27. The tray of claim 26, wherein the upper construct includes a plurality of attachment panels foldably connected to the upper flange panel.

28. The tray of claim 27, wherein at least one of the plurality of attachment panels is foldably connected to the upper base panel.

29. The tray of claim 28, wherein the attachment panels are in face-to-face contact with a respective one of the plurality of lower side panels.

30. The tray of claim 25, wherein the upper divider panel is a first upper divider panel and the upper construct comprises a second upper divider panel, and the lower divider panel is a first lower divider panel and the lower construct comprises a second lower divider panel.

31. The tray of claim 30, wherein the divider is a first divider and the first upper divider panel and the first lower divider panel cooperate to form the first divider and the second upper divider panel and the second lower divider panel cooperate to form a second divider in the interior of the tray.
